(19) United States
(12) Patent Application Publication
(10) Pub. No.: US 2022/0334216 A1
(43) Pub. Date: Oct. 20, 2022

(54) APPARATUS, SYSTEM AND METHOD OF DETECTING INTERFERENCE IN A RADAR RECEIVE (RX) SIGNAL

(71) Applicant: Intel Corporation, Santa Clara, CA (US)

(72) Inventors: Lior Maor, Petah Tikva (IL); Dan Ohev Zion, Ra'anana (IL); Sharon Heruti, Tel-Aviv (IL); Alon Cohen, Modiin (IL)

(73) Assignee: Intel Corporation, Santa Clara, CA (US)

(21) Appl. No.: 17/854,192

(22) Filed: Jun. 30, 2022

(51) Int. Cl. G01S 7/02; G01S 13/931

(52) U.S. Cl. CPC G01S 7/023; G01S 13/931

(57) ABSTRACT

For example, an apparatus may include an interference detector configured to detect interference in a radar Received (Rx) signal. The interference detector may include an input to receive Transmit (Tx) parameter information of a radar Tx signal, wherein the radar Rx signal is based on the radar Tx signal; and a processor configured to determine interference detection information of an interfering signal based on the radar Rx signal and the Tx parameter information. The interference detection information may include one or more signal parameters corresponding to a shape of the interfering signal, and interference level information to indicate a level of noise caused by the interfering signal in the radar Rx signal.

### TECHNICAL FIELD

Aspects described herein generally relate to detecting interference in a radar receive (Rx) signal.

### BACKGROUND

Various types of devices and systems, for example, autonomous and/or robotic devices, e.g., autonomous vehicles and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LiDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of an apparatus including an interference detector, in accordance with some demonstrative aspects.

FIG. 11 is a schematic illustration of an apparatus including an interference detector, in accordance with some demonstrative aspects.

FIG. 12A is a schematic illustration of an interfering signal affecting a radar Rx signal, FIG. 12B is a graph depicting a noise level corresponding to the interfering signal, and FIG. 12C is a graph depicting an interference level of the interfering signal, in accordance with some demonstrative aspects.

FIG. 13 is a schematic illustration of an interference-information extraction scheme to extract interference detection information of an interfering signal, in accordance with some demonstrative aspects.

FIG. 14 is a schematic illustration of an interference-information extraction scheme to extract interference detection information of an interfering signal, in accordance with some demonstrative aspects.

FIG. 15 is a schematic illustration of a graph depicting an output of a correlator of a radar device, in accordance with some demonstrative aspects.

FIG. 16 is a schematic flow chart illustration of a method of detecting interference in a radar Rx signal, in accordance with some demonstrative aspects.

FIG. 17 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects” “one embodiment”, “an embodiment”, “demonstrative embodiment”, “various embodiments” etc., indicate that the aspect(s) and/or aspects so described may include a particular feature, structure, or characteristic, but not every aspect or embodiment necessarily includes the particular feature, structure, or characteristic. Further, repeated use of the phrase “in one aspect” or “in one embodiment” does not necessarily refer to the same aspect or aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, the circuitry may be implemented in, or functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

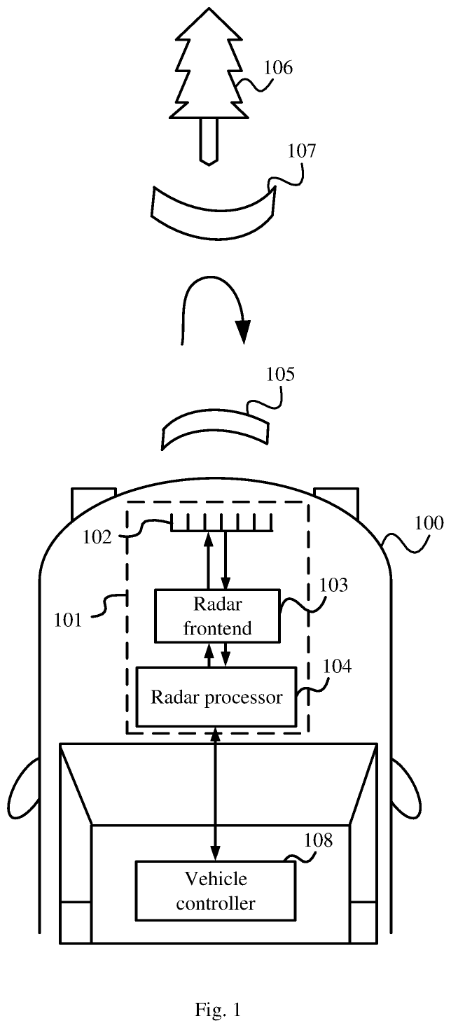

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar devices, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include other vehicles; pedestrians; traffic signs; traffic lights; roads, road elements, e.g., a pavement-road meeting, an edge line; a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

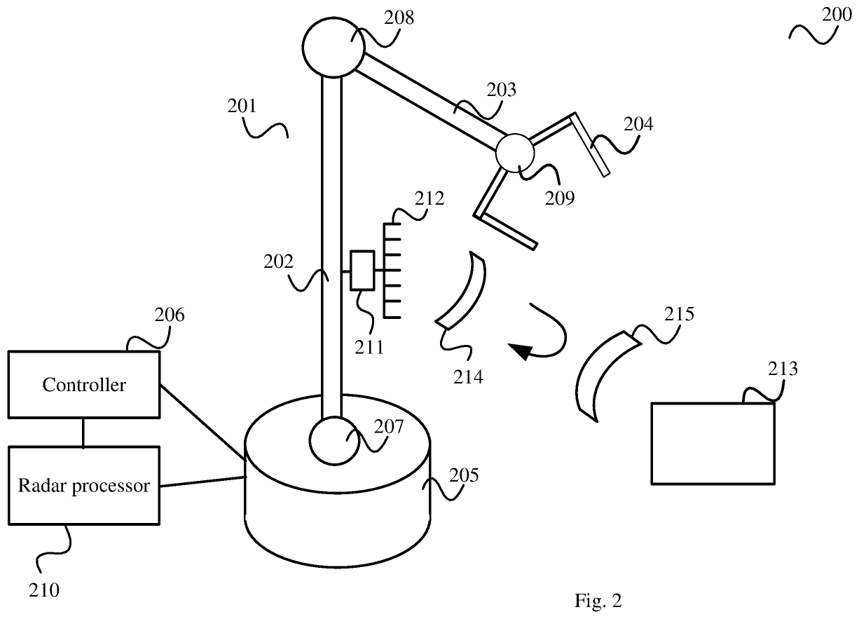

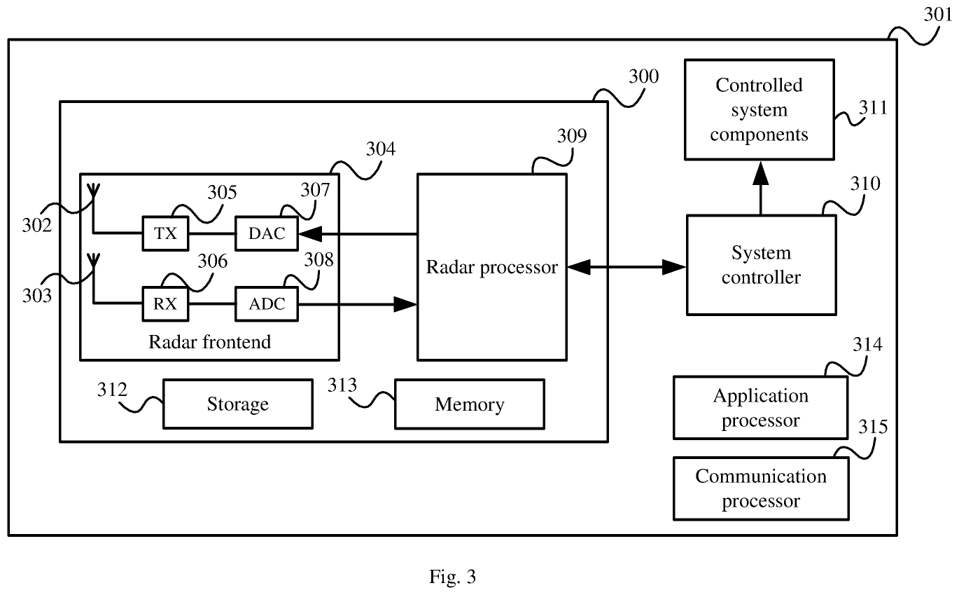

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, system controller 310 may be configured to control one or more controlled system components 311 of the system 301, e.g. a motor, a brake, steering, and the like, e.g. by one or more corresponding actuators.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated continuous wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

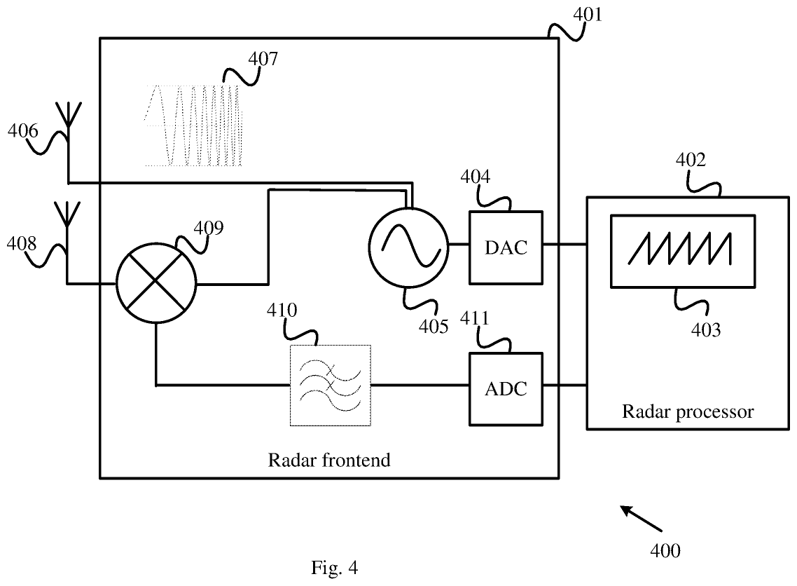

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

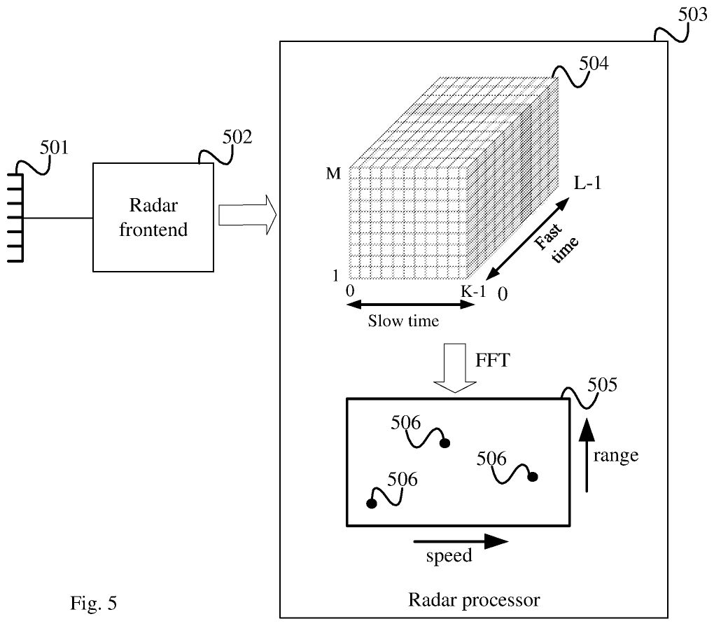

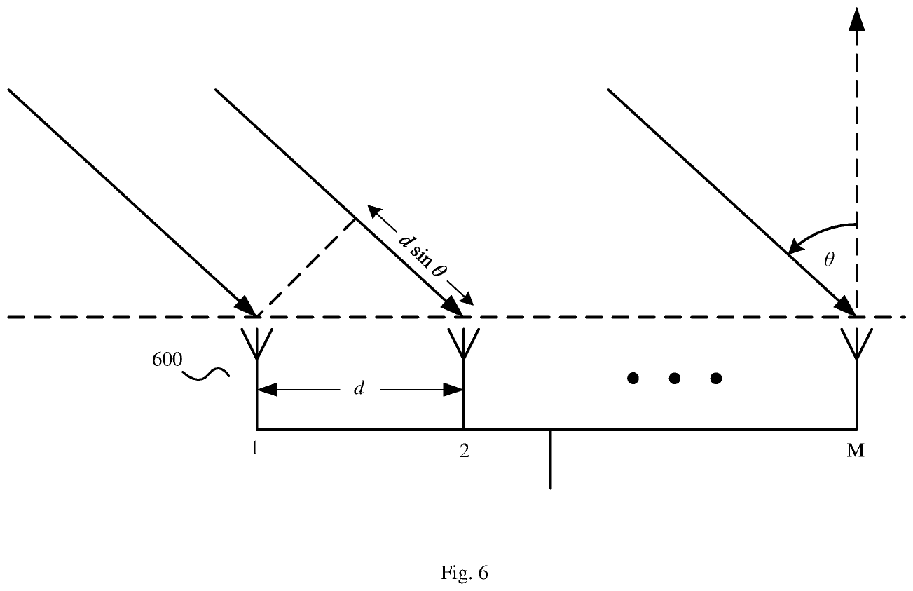

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

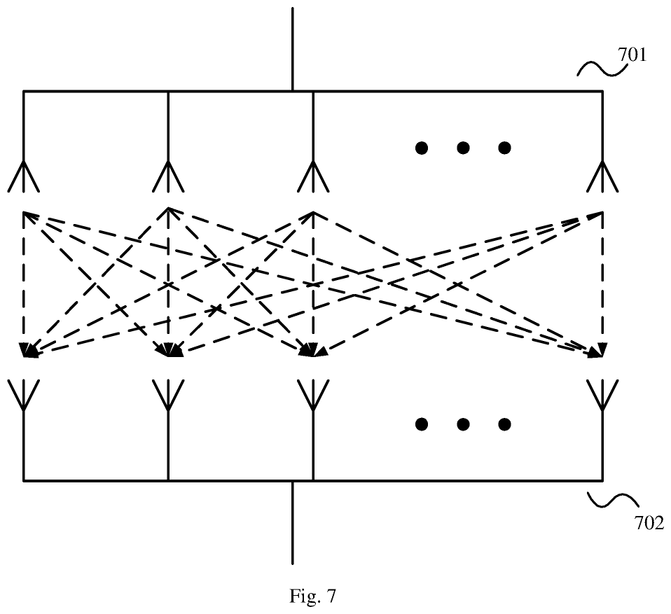

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

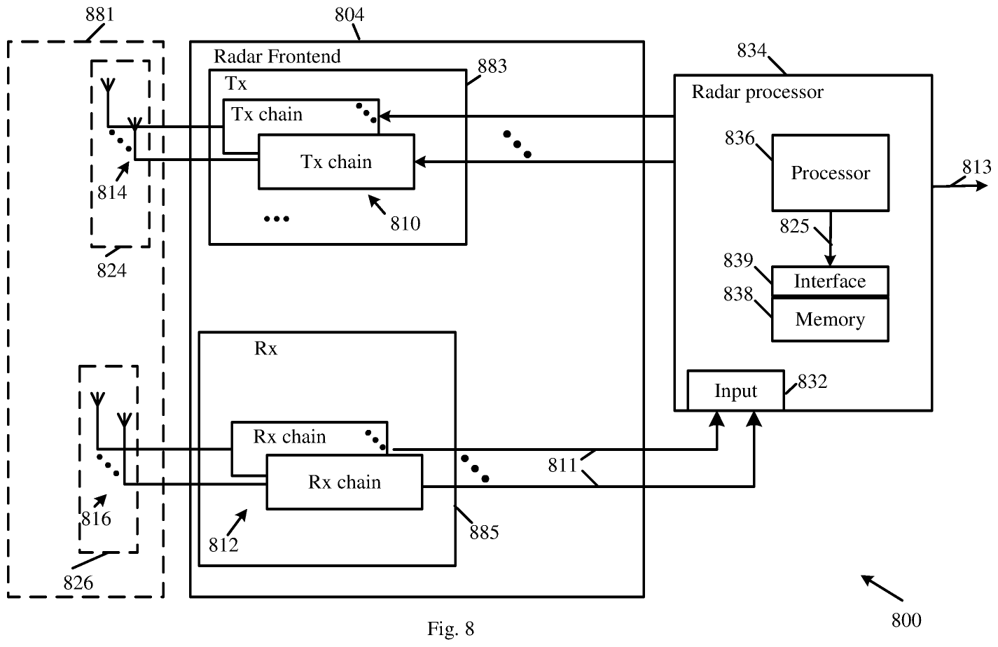

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm and/or procedure may be utilized to generate the range information and/or Doppler information.

In some demonstrative aspects, memory 838 may be configured to store AoA information, which maybe generated by processor 836, for example, based on the radar Rx data, the range information and/or Doppler information. In one example, the AoA information may be determined based on an AoA estimation algorithm. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

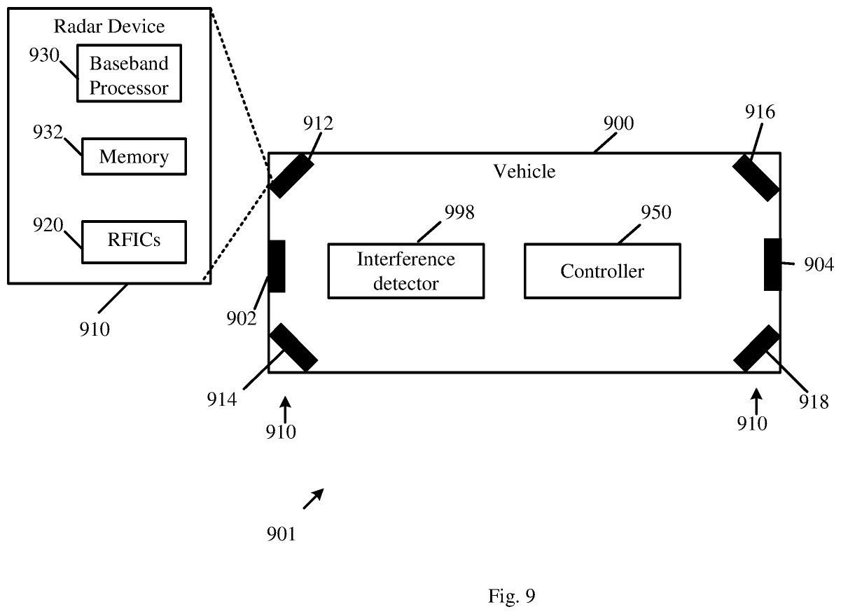

Reference is made to FIG. 9, which schematically illustrates a radar system 901 including a plurality of radar devices 910 implemented in a vehicle 900, in accordance with some demonstrative aspects.

In some demonstrative aspects, as shown in FIG. 9, the plurality of radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of radar devices 910 may include, for example, six radar devices 910, e.g., as described below.

In some demonstrative aspects, the plurality of radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of radar devices 910 may include any other number of radar devices 910, e.g., less than six radar devices or more than six radar devices.

In other aspects, the plurality of radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first radar device 902, e.g., a front radar device, at a front-side of vehicle 900.

In some demonstrative aspects, as shown in FIG. 9, vehicle 900 may include a second radar device 904, e.g., a back radar device, at a back-side of vehicle 900.

In some demonstrative aspects, as shown in FIG. 9, vehicle 900 may include one or more of radar devices at one or more respective corners of vehicle 900. For example, vehicle 900 may include a first corner radar device 912 at a first corner of vehicle 900, a second corner radar device 914 at a second corner of vehicle 900, a third corner radar device 916 at a third corner of vehicle 900, and/or a fourth corner radar device 918 at a fourth corner of vehicle 900.

In some demonstrative aspects, vehicle 900 may include one, some, or all, of the plurality of radar devices 910 shown in FIG. 9. For example, vehicle 900 may include the front radar device 902 and/or back radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the radar devices 910.

In some demonstrative aspects, at least part of the functionality of radar system controller 950 may be implemented by a dedicated controller, e.g., a dedicated system controller or central controller, which may be separate from the radar devices 910, and may be configured to control some or all of the radar devices 910.

In some demonstrative aspects, at least part of the functionality of radar system controller 950 may be implemented as part of at least one radar device 910.

In some demonstrative aspects, at least part of the functionality of radar system controller 950 may be implemented by a radar processor of at least one of the radar devices 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, a radar device 910 of the plurality of radar devices 910, e.g., each radar device 910, may include a baseband processor 930 (also referred to as a “Baseband Processing Unit (BPU)”), which may be configured to control communication of radar signals by the radar device 910, and/or to process radar signals communicated by the radar device 910. For example, baseband processor 930 may include one or more elements of radar processor 834 (FIG. 8), and/or may perform one or more operations and/or functionalities of radar processor 834 (FIG. 8).

In some demonstrative aspects, baseband processor 930 may include one or more components and/or elements configured for digital processing of radar signals communicated by the radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, radar device 910 may include a memory 932, which may be configured to store data processed by, and/or to be processed by, baseband processor 910. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In some demonstrative aspects, as shown in FIG. 9, radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., radar device 910, may be implemented in one or more devices and/or systems, for example, a vehicle, e.g., vehicle 900, to provide a technical solution for robust, accurate, and/or efficient detection of objects.

For example, the radar device may be less prone to weather effects. Accordingly, the radar device may provide an important, or even critical, component for detecting objects in some use cases and/or scenarios, e.g., in bad weather conditions.

In some demonstrative aspects, there may be a need to provide a technical solution to mitigate radio interference between radar devices, for example, radio interference at radar devices of vehicle 900 (FIG. 9), which may be caused by radar communications from other radar devices, e.g., of other vehicles, and/or one or more other radar communication sources, e.g., as described below.

In some demonstrative aspects, a number of vehicles equipped with radar devices may be expected to grow, for example, as importance of a radar sensor as an autonomous driving major sensor increases.

In some demonstrative aspects, radio interference between radar devices may be expected to grow as well, e.g., as a result of the increase in the number of autonomous vehicles utilizing radar devices. Accordingly, it may be important, or even critical in some scenarios, or an automotive radar device to be capable of working concurrently with other automotive radar devices.

In some demonstrative aspects, radio interference between radar devices may affect the performance of the radar devices, for example, in terms of a degraded radar effective range, a reduced probability of detections, an increase in a number of false alarm detections, and/or any other effects, which may degrade the radar performance.

In one example, reliability and/or immunity in the presence of an interference signal may be a challenging requirement from an automotive radar system.

In some demonstrative aspects, a 76 GHz-81 GHz frequency band may be allocated for automotive radar devices, e.g., by a regulatory authority, and a wide BW signal, e.g., from 250 MHz up to 2 GHz or any other BW, may be used by the automotive radar devices, for example, to support a growing requirement for improved range resolution.

In one example, e.g., in one scenario, when two radar sensors transmit at a same time and at a same frequency in relatively close proximity, a radar sensor, e.g., each radar sensor, may receive transmissions of the other radar sensor, e.g., along with reflections of its own transmissions. This scenario may degrade a radar sensitivity to detect objects, for example, as the radar sensors may ‘blind’ each other.

In another example, in some situations, reception at a radar sensor of transmissions from other radar sensors may create false detections, e.g., ‘phantom detections’, which may result in wrong autonomous driving decisions.

In some demonstrative aspects, concurrent transmissions from multiple radar devices may occur in a two-lane proximity scenario, where two vehicles may be located side by side and driving at a high speeds within two road lanes, e.g., in a highway, major city roads, and/or the like.

In some demonstrative aspects, concurrent transmissions from multiple radar devices may occur in a dense urban scenario, e.g., in an urban environment, where a vehicle may be surrounded from some or even all directions by other vehicles, e.g., in a scenario of slow traffic in multiple adjacent lanes. According to this example, there may be a high probability that radars of other vehicles may block or degrade the radar capability of a radar of a vehicle to detect one or more targets, e.g., pedestrians, cyclists and/or the like, which may appear with other vehicles.

In some demonstrative aspects, concurrent transmissions from multiple radar devices may occur in a vehicle passing by scenario, where two vehicles may pass by each other in a bi-directional road.

In other aspects, concurrent transmissions from multiple radar devices may occur in any other additional or alternative day to day scenarios, where two or more vehicles may be located in close proximity to each other.

In some demonstrative aspects, for example, in some use cases, scenarios, and/or implementations, there may be one or more disadvantages, inefficiencies, and/or technical problems to implement one or methods to avoid radar interference between radar devices, e.g., as described below.

In one example, in some use cases, scenarios, and/or implementations, there may be one or more disadvantages, inefficiencies, and/or technical problems to implement a frequency separation technique to avoid radar interference. For example, the frequency separation technique be based on radar sensors operating at different frequencies, sufficiently separated, for example, so that each radar sensor may be able to filter radar interferences from other radar sensors.

In another example, in some use cases, scenarios, and/or implementations, there may be one or more disadvantages, inefficiencies, and/or technical problems to implement a time separation technique to avoid radar interference. For example, the time separation technique may be based on radar sensors operating at different times. For example, the time separation technique may be suitable to ensure no performance degradation.

In another example, in some use cases, scenarios, and/or implementations, there may be one or more disadvantages, inefficiencies, and/or technical problems to implement a coding separation technique to avoid radar interference. For example, the coding separation technique may be based on radar sensors using orthogonal codes to modulate their transmissions, for example, to avoid interfering with each other.

In some demonstrative aspects, these techniques to avoid radar interference, may not be feasible, for example, as there is still no standard and/or infrastructure, which may support synchronization between the different radar sensors.

In some demonstrative aspects, a radar device, e.g., radar device 910, may be configured to implement an interference detection mechanism, which may be configured to provide a technical solution to support detection and/or avoidance of radar interference independently, e.g., without any synchronization with other radar devices, e.g., as described below.

For example, the interference detection mechanism may be configured to provide a technical solution to ensure suitable radar performance in automotive radar devices.

In some demonstrative aspects, for example, in some use cases, scenarios, and/or implementations, there may be one or more disadvantages, inefficiencies, and/or technical problems in implementations based on a Listen Before Talk (LBT) technique to mitigate and/or avoid radar interference. For example, according to the LBT technique a radar device may sense the air at an operation frequency of the radar device, and the radar device may be allowed to start to transmit, e.g., only if the air is free from other radar transmissions.

In one example, there may be a high probability that other radar devices may start transmitting after the radar device started to transmit, for example, even if the channel was initially free, for example, in case automotive radar devices are unsynchronized and/or not standardized.

In another example, automotive radar devices may be configured to expect relatively strict constraints on a timing of an image scan report, and therefore, a high latency Jitter may not be tolerable.

In some demonstrative aspects, for example, in some use cases, scenarios, and/or implementations, there may be one or more disadvantages, inefficiencies, and/or technical problems in implementations based on a frequency hopping technique to mitigate and/or avoid radar interference. For example, according to the frequency hopping technique a radar device may “hop” between a set of center frequencies during its operation, e.g., using a random series, for example, to reduce a probability of two radar devices operating in a same frequency.

In one example, the frequency hopping technique may be suitable for use with a narrow signal BW. However, implementing the frequency hopping technique with a wide signal BW for automotive radar devices in a relatively limited frequency band, e.g., the 76-81 GHz frequency band, and in a dense environment, may result in a long denial of service, and/or a significant degradation in performance, e.g., which may not be acceptable in safety related automotive use cases.

In some demonstrative aspects, for example, in some use cases, scenarios, and/or implementations, there may be one or more disadvantages, inefficiencies, and/or technical problems when implementing a highly-linear RF receiver to mitigate and/or avoid radar interference. For example, highly-linear RF receiver may include an RF receiver chain configured to handle strong interferences, e.g., to reduce a degradation in performance, for example, in scenarios where multiple radar sensors transmit simultaneously.

In one example, implementing the highly-linear RF receiver for radar use cases may degrade radar performance, for example, when there is no interference, e.g., a radar max detection range may be reduced.

In another example, the highly-linear RF receiver may be capable of reducing performance degradation, for example, in cases of radar devices working in neighboring frequencies. For example, for other scenarios, e.g., when radar devices are working at a same frequency, using the highly-linear RF receiver alone may not be sufficient.

In another example, the highly-linear RF receiver may have an increased power consumption, which may require more expensive thermal handling solutions for some implementations.

In some demonstrative aspects, for example, in some use cases, scenarios, and/or implementations, there may be one or more disadvantages, inefficiencies, and/or technical problems when implementing an error correction technique to mitigate and/or avoid radar interference. For example, when a collision with an interfering signal occurs, errors in a received transmission may be corrected based on neighboring samples or frames.

In one example, the error correction technique may be limited, and/or may be efficient with only some types of interference, e.g. sporadic and/or ultra-short interferences.

In some demonstrative aspects, a radar system e.g., system 901, may utilize an interference detector 998, which may be configured to provide a technical solution for mitigation of an interference in a radar Rx signal, e.g., as described below.

In some demonstrative aspects, the interference detector 998 may be implemented, for example, as part of a radar system, for example, radar system 901, e.g., as described below.

In some demonstrative aspects, the interference detector 998 may be implemented, for example, as part of a radar device, e.g., radar device 910.

In some demonstrative aspects, the interference detector 998 may be implemented, for example, as part of a radar controller, e.g., radar controller 950.

In some demonstrative aspects, the interference detector 998 may be implemented, for example, as a separate part and/or element of a radar system, for example, radar system 901.

In some demonstrative aspects, the interference detector 998 may be implemented, for example, as part of any other element and/or component of a radar system, for example, radar system 901.

In some demonstrative aspects, the interference detector 998 may be implemented, for example, as a standalone low-power wide-bandwidth interference Rx only detector unit, which may be configured to operate, for example, during radar operation, for example, over a whole radar frequency band, e.g., as described below.

In some demonstrative aspects, the interference detector 998 may be configured to scan and look for other radar transmissions, for example, over some or all of the radar frequency band, e.g., as described below.

In some demonstrative aspects, the interference detector 998 may be configured to work concurrently, e.g., completely concurrently, with radar receivers, e.g., Rx 885 (FIG. 8) of radar devices 910, for example, regardless of a current radar operating frequency of the radar receivers, e.g., as described below.

In some demonstrative aspects, the interference detector 998 may be configured to indicate to a radar device, e.g., a radar device 910, an available time and/or frequency slot for radar transmissions to be performed by the radar device. For example, this indication of the available time and/or frequency slot may provide a technical solution to reduce, e.g., minimize, a duration of a radar availability loss, e.g., as described below.

In some demonstrative aspects, the interference detector 998 may be configured to detect and characterize an interfering signal in a received transmission, e.g., as described below.

In some demonstrative aspects, the interference detector 998 may be configured to characterize one or more parameters of the interfering signal, for example, a center frequency of the interfering signal, a bandwidth of the interfering signal, a slope of the interfering signal, a power of the interfering signal, a duration of the interfering signal, and/or any other additional or alternative parameter of the interfering signal, e.g., as described below.

In some demonstrative aspects, the interference detector 998 may be configured to provide the one or more parameters of the interfering signal to a radar processor, e.g., radar processor 834 (FIG. 8) and/or controller 950, e.g., as described below.

In some demonstrative aspects, the radar processor, e.g., radar processor 834 (FIG. 8) and/or controller 950, may be configured to determine a mitigation scheme to mitigate the interference signal, for example, based on the one or more parameters of the interfering signal, e.g., as described below.

In some demonstrative aspects, the mitigation scheme may be configured to include an avoidance mitigation scheme to avoid the interfering signal. For example, the radar processor may be configured to change one or more of its current mode parameters to different ones, for example, to minimize an aggressor impact of the interfering signal.

In some demonstrative aspects, the mitigation scheme may be configured to include a cancellation mitigation scheme to cancel, partially or entirely, an effect of the interfering signa. For example, the radar processor may be configured to cancel the effect of the interfering signal, for example, by performing a coherent estimation and subtraction of the interfering signal. For example, the coherent estimation and subtraction of the interfering signal may be achieved based on estimating a channel response of a template of a transmitted Tx signal, e.g., from Tx baseband to Rx baseband.

In some demonstrative aspects, the mitigation scheme may include a combined mitigation scheme, e.g., including a combination of the cancelation and avoidance mitigation schemes. For example, the processor may be configured to cancel the interfering signal in a current frame, and to avoid the interfering signal for one or more next frames.

In some demonstrative aspects, the interference detector 998 may be implemented to provide a technical solution to support high availability of radar frame reports by a radar device, e.g., radar device 910. For example, the high availability of radar frame reports may support a requirement for safe autonomous driving decisions, which may minimize and/or avoid, e.g., in advance, interferences from aggressors, e.g., an aggressor long collision.

In some demonstrative aspects, the interference detector 998 may be implemented to provide a technical solution to support flexibility in operation of a radar device, e.g., radar device 910, for example, by allowing any suitable concurrency of an operating radar receiver and the interference detector 998, e.g., as described below.

In some demonstrative aspects, the interference detector 998 may be implemented to provide a technical solution to support an improved battery life for a radar device, e.g., radar device 910, and/or a vehicle, e.g., vehicle 900. For example, a vehicle battery life may become a key factor in an Electric Vehicle (EV), for example, where battery lifetime defines a maximal distance per charging. For example, low power consumption and/or a flexible architecture for interference detection may support low power interference detection, for example, in parallel to radar activity of the radar device, e.g., as described below.

In some demonstrative aspects, the interference detector 998 may be implemented to provide a technical solution to support a low silicon footprint.

In some demonstrative aspects, the interference detector 998 may be implemented to provide a technical solution to support a deterministic, e.g., even a 100% deterministic, cancellation of an interfering radar signal. For example, a suppression achieved for a current frame may be guaranteed to be translated into a sensitivity gain, for example, in opposed to predicting a next free slot, e.g., in frequency and/or time, which may not be 100% predictable, for example, in high dynamically changing environments.

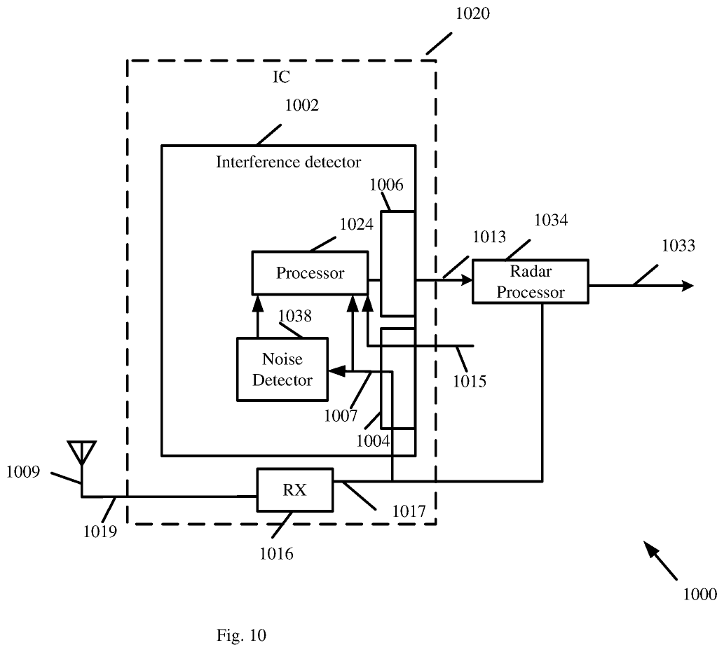

Reference is made to FIG. 10, which schematically illustrates an apparatus 1000 including an interference detector 1002, in accordance with some demonstrative aspects.

In some demonstrative aspects, interference detector 1002 may be configured to detect interference in a radar Rx signal 1007, e.g., as described below.

In some demonstrative aspects, as shown in FIG. 10, interference detector 1002 may include an input 1004 to receive Tx parameter information 1015 of a radar Tx signal, e.g., as described below.

In some demonstrative aspects, interference detector 1002 may receive Tx parameter information 1015 from a controller and/or a processor of a radar device and/or system implementing interference detector 1002, e.g., as described below.

In some demonstrative aspects, the radar Rx signal 1007 may be based on the radar Tx signal, e.g., as described below. In one example, the radar Rx signal 1007 may be received via input 1004. In other aspects, the radar Rx signal 1007 may be received via any other input or connection.

In some demonstrative aspects, as shown in FIG. 10, interference detector 1002 may include a processor 1024 configured to determine interference detection information 1013 of an interfering signal, for example, based on the radar Rx signal 1007 and the Tx parameter information 1015, e.g., as described below.

In some demonstrative aspects, processor 1024 may include, or may be implemented, partially or entirely, by circuitry and/or logic, e.g., one or more processors including circuitry and/or logic, memory circuitry and/or logic. Additionally or alternatively, one or more functionalities of processor 1024 may be implemented by logic, which may be executed by a machine and/or one or more processors, e.g., as described below.

In some demonstrative aspects, the interference detection information 1013 may include one or more signal parameters corresponding to a shape of the interference signal, e.g., as described below.

In some demonstrative aspects, the one or more signal parameters may include a bandwidth of the interfering signal, e.g., as described below.

In some demonstrative aspects, the one or more signal parameters may include a center frequency of the interfering signal, e.g., as described below.

In some demonstrative aspects, the one or more signal parameters may include a slope of the interfering signal, e.g., as described below.

In some demonstrative aspects, the one or more signal parameters may include a duration of the interfering signal, e.g., as described below.

In other aspects, the one or more signal parameters may include any other additional and/or alternative parameters corresponding to the interference signal.

In some demonstrative aspects, the interference detection information 1013 may include interference level information to indicate a level of noise caused by the interfering signal in the radar Rx signal 1007, e.g., as described below.

In other aspects, the interference detection information 1013 may include any other additional or alternative information relating to and/or based on the interfering signal.

In some demonstrative aspects, as shown in FIG. 10, interference detector 1002 may include an output 1006 to output the interference detection information 1013, e.g., as described below.

In some demonstrative aspects, as shown in FIG. 10, apparatus 1000 may include at least one Rx chain 1016 to provide to the processor 1024 a digital radar Rx signal 1017 based on an RF radar Rx signal 1019, e.g., as described below.

In some demonstrative aspects, as shown in FIG. 10, apparatus 1000 may include an antenna 1009 connected to the Rx chain 1016, e.g., as described below.

In some demonstrative aspects, the antenna 1009 may receive the RF radar Rx signal 1019, e.g., as described below.

In some demonstrative aspects, interference detector 1002 may be implemented as a separate and/or independent component of a radar system, for example, to detect interference via radar Rx signals received and/or processed by one or more separate and/or dedicated antennas 1009 and/or Rx chains 1016. For example, antennas 1009 and/or Rx chains 1016 may be implemented separately from one or more antennas and/or Rx chains of a radar device and/or system implementing the interference detector 1002.

In some demonstrative aspects, as shown in FIG. 10, apparatus 1000 may include an IC 1020 including the interference detector 1002 and the at least one Rx chain 1016, e.g., as described below.

For example, IC 1020 may be implemented as a separate and/or dedicated interference detection chip, which may be separate from and/or independent from other Rx/Tx components of the radar device and/or system implementing the interference detector 1002.

For example, IC 1020 may be implemented as a separate and/or dedicated interference detection chip, which may be separate from and/or independent from Rx antennas and/or Rx chains of the radar device and/or system implementing the interference detector 1002.

In some demonstrative aspects, for example, IC 1020 may be implemented to detect interference independent from an operation of the radar device and/or system implementing the interference detector 1002.

For example, IC 1020 may be implemented to provide a technical solution to support interference detection over on or more frequencies, for example, according to a flexibly and/or dynamic frequency setting, e.g., which may be independent of and/or may not impact, a main receiver frequency of the radar device and/or system implementing the interference detector 1002.

example, IC 1020 may be implemented to provide a technical solution to support interference detection over on or more frequencies, for example, according to a flexibly and/or dynamic frequency setting, which may be configured for dynamic detection of radar aggressors.

In other aspects, interference detector 1002 may be implemented as an integrated component of a radar system, for example, to detect interference via radar Rx signals received and/or processed by one or more antennas 1009 and/or Rx chains 1016, which may be commonly shared with a radar device and/or system implementing the interference detector 1002.

For example, interference detector 1002 may be configured to receive the radar Rx signal from independent from Rx antennas and/or Rx chains of the radar device and/or system implementing the interference detector 1002.

In some demonstrative aspects, as shown in FIG. 10, apparatus 1000 may include a radar processor 1034 configured to mitigate noise caused by the interfering signal in the radar Rx signal 1007, e.g., as described below.

In some demonstrative aspects, radar processor 1034 may be configured to mitigate noise caused by the interfering signal in the radar Rx signal 1007, for example, based on the interference detection information 1013, e.g., as described below.

In some demonstrative aspects, radar processor 1034 may be configured to mitigate noise caused by the interfering signal in the radar Rx signal 1007, for example, based on the one or more signal parameters corresponding to a shape of the interference signal, as indicated by interference detection information 1013, e.g., as described below.

In some demonstrative aspects, as shown in FIG. 10, radar processor 1034 may be configured to generate radar information 1033, for example, based on the radar Rx signal 1007.

In some demonstrative aspects, for example, radar processor 834 (FIG. 8) may include one or more elements of processor 1034, and/or may perform one or more operations and/or functionalities of processor 1034; BB processor 930 (FIG. 9) may include one or more elements of processor 1034, and/or may perform one or more operations and/or functionalities of processor 1034; and/or controller 950 (FIG. 9) may include one or more elements of processor 1034, and/or may perform one or more operations and/or functionalities of processor 1034.

In some demonstrative aspects, processor 1024 may be configured to generate the interference detection information 1013 including interference level information, which may include a selected interference level value from a plurality of predefined interference level values, e.g., as described below.

In some demonstrative aspects, the selected interference level value may indicate the level of noise caused by the interfering signal relative to the plurality of predefined interference level values, e.g., as described below.

In some demonstrative aspects, processor 1024 may be configured to generate the interference detection information 1013 including interference level information, which may be configured to indicate a Signal to Interference Noise Ratio (SINR) of the radar Rx signal 1007, e.g., as described below.

In some demonstrative aspects, processor 1024 may be configured to determine the interference level information, for example, based on a level of a noise floor of the radar Rx signal 1007, e.g., as described below.

In some demonstrative aspects, processor 1024 may be configured to determine the interference level information, for example, based on a level of detected noise in the radar Rx signal 1007, e.g., as described below.

In some demonstrative aspects, as shown in FIG. 10, interference detector 1002 may include a noise detector 1038 to detect the level of detected noise in the radar Rx signal 1007, e.g., as described below.

In some demonstrative aspects, noise detector 1038 may be configured to detect the level of the noise floor of the radar Rx signal 1007, e.g., as described below.

In other aspects, processor 1024 may be configured to generate the interference detection information 1013 including any other additional or alternative interference level information.

In some demonstrative aspects, processor 1024 may be configured to determine an estimated interference signal, for example, based on the radar Rx signal 1007 and the Tx parameter information 1015, e.g., as described below.

In some demonstrative aspects, processor 1024 may be configured to generate the interference detection information 1013 including one or more signal parameters of the interfering signal, which may be determined, for example, based on the estimated interference signal, e.g., as described below.

In some demonstrative aspects, processor 1024 may be configured to determine t an estimated Rx signal based on a correlation between the Tx parameter information 1015 and the radar Rx signal 1007, e.g., as described below.

In some demonstrative aspects, processor 1024 may be configured to determine the estimated interference signal, for example, based on the estimated Rx signal and the radar Rx signal 1007, e.g., as described below.

In some demonstrative aspects, processor 1024 may be configured to identify a frequency bandwidth between a first frequency and a second frequency in a power spectrum of the estimated interference signal, e.g., as described below.

In some demonstrative aspects, processor 1024 may be configured to determine at least one signal parameter of the interfering signal, for example, based on the first frequency and the second frequency, e.g., as described below.

In some demonstrative aspects, processor 1024 may be configured to determine an estimated bandwidth of the interfering signal, for example, based on the first frequency and the second frequency, e.g., as described below.

In some demonstrative aspects, processor 1024 may be configured to generate the interference detection information 1013 including the estimated bandwidth of the interfering signal, e.g., as described below.

In some demonstrative aspects, processor 1024 may be configured to determine an estimated center frequency of the interfering signal, for example, based on the first frequency and the second frequency, e.g., as described below.

In some demonstrative aspects, processor 1024 may be configured to generate the interference detection information 1013 including the estimated center frequency of the interfering signal, e.g., as described below.

In some demonstrative aspects, processor 1024 may be configured to determine a correlated signal, e.g., a single-tap correlated signal, for example, by applying a correlation, e.g., a single-tap correlation, to the estimated interference signal, e.g., as described below.

In some demonstrative aspects, processor 1024 may be configured to determine the one or more signal parameters of the interfering signal, for example, based on the correlated signal, e.g., the single-tap correlated signal, e.g., as described below.

In some demonstrative aspects, processor 1024 may be configured to determine an estimated slope of the interfering signal, for example, based on a time delay of the single tap correlation, and based on a center frequency of a range of frequencies in a power spectrum of the correlated signal, e.g., the single-tap correlation signal, e.g., as described below.

In some demonstrative aspects, processor 1024 may be configured to determine the estimated slope of the interfering signal, for example, based on a spectrogram of the estimated interference signal, e.g., as described below.

In some demonstrative aspects, processor 1024 may be configured to generate the interference detection information 1013 including the estimated slope of the interfering signal, e.g., as described below.

In some demonstrative aspects, processor 1024 may be configured to detect a two-dimensional pixel image based on the spectrogram of the estimated interference signal, e.g., as described below.

In some demonstrative aspects, processor 1024 may be configured to transform the two-dimensional pixel image into a transformed image defining a plurality of lines, e.g., as described below.

In some demonstrative aspects, the transformed image may include a Hough transformed image based on a Hough transformation, e.g., as described below.

In some demonstrative aspects, the transformed image may be generated based on any other transformation.

In some demonstrative aspects, processor 1024 may be configured to identify one or more detected lines in the two-dimensional pixel image, for example, based one or more peaks of the transformed image, e.g., as described below.

In some demonstrative aspects, processor 1024 may be configured to determine the slope of the interfering signal, for example, based on a slope of the one or more detected lines in the two-dimensional pixel image, e.g., as described below.

In other aspects, processor 1024 may be configured to determine the estimated slope of the interfering signal based on any other additional or alternative estimation and/or parameter.

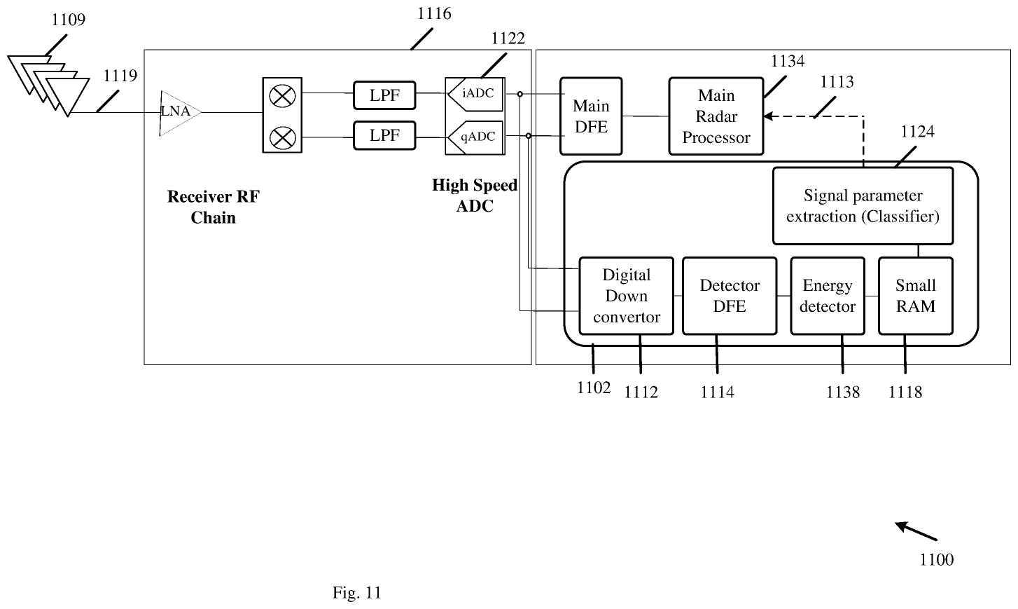

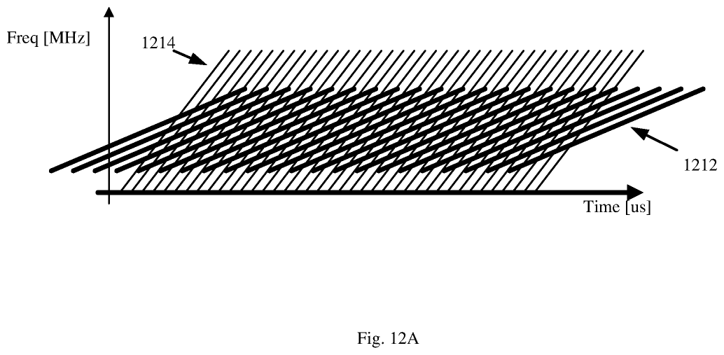

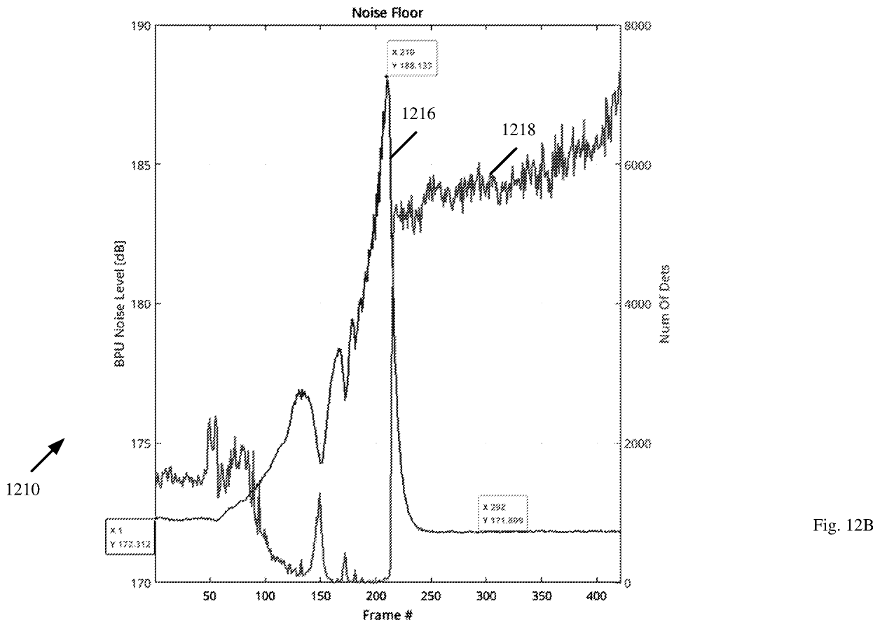

Reference is made to FIG. 11, which schematically illustrates an apparatus 1100 including an interference detector 1102, in accordance with some demonstrative aspects. For example, apparatus 1000 (FIG. 10) may include one or more elements of apparatus 1100, and/or may perform one or more operations and/or functionalities of apparatus 1100; and/or interference detector 1002 (FIG. 10) may include one or more elements of interference detector 1102, and/or may perform one or more operations and/or functionalities of interference detector 1102.

In some demonstrative aspects, interference detector 1102 may be configured to detect interference in a radar Rx signal, e.g., a digital radar Rx signal, from an Rx RF chain 1116, e.g., as described below. For example, the Rx RF chain 1116 may be configured to provide to detector 1102 the digital radar Rx signal based on an RF radar signal received via an antenna 1109, which may be connected to the Rx RF chain 1116.

In some demonstrative aspects, as shown in FIG. 11, interference detector 1102 may include a processor 1124 configured to determine interference detection information 1113 of an interfering signal based on the radar Rx signal, e.g., as described below.

In one example, processor 1124 may include a signal parameter extraction module including several sub-modules, for example, for simultaneously estimating different parameters of the interfering signal.

In some demonstrative aspects, as shown in FIG. 11, apparatus 1100 may include a radar processor 1134 configured to mitigate noise caused by an interfering signal in the radar Rx signal 1107, for example, based on the interference detection information 1113. For example, processor 1024 (FIG. 10) may include one or more elements of processor 1134, and/or may perform one or more operations and/or functionalities of processor 1134.

In some demonstrative aspects, interference detector 1102 may be implemented by a radar device to provide a technical solution to support detection and/or avoidance of a radar interferer (also referred to as “same band radar aggressor”), e.g., on a same radar frequency band used by the radar device. For example, interference detector 1102 may be implemented to provide a technical solution to support a flexible HW implementation, which may enable a low power solution, for example, to ensure meeting stringent radar availability requirements, for example, at autonomous radar devices, e.g., Autonomous Vehicles (AVs) and/or ADAS applications.

In some demonstrative aspects, interference detector 1102 may be implemented to provide a technical solution employing several digital chains and/or a flexible frequency setting, for example, for dynamic detection of aggressors over dynamically-selected frequency channels and/or bands. For example, interference detector 1102 may be implemented to provide a technical solution for interference detection over a dynamic frequency setting, e.g., even without impacting a frequency of a main receiver of the radar device.

In some demonstrative aspects, Rx chain 1116 may be shared between the main receiver of the radar device and interference detector 1102, e.g., as described below.

In some demonstrative aspects, Rx chain 1120 may be implemented as a dedicated, e.g., not-shared, Rx chain, which may be dedicated for interference detection and may be, for example, separate from a main receiver chain of the radar device.

In some demonstrative aspects, as shown in FIG. 11, Rx Rf chain 1116 may include an ADC 1122, e.g., a high speed ADC having a high sampling rate, to generate a digital radar Rx signal based on the RF radar signal received by antenna 1109.

In some demonstrative aspects, as shown in FIG. 11, interference detector 1102 may implement components of a digital receiver architecture, e.g., a configurable digital receiver with dynamic frequency selection, for example, using digital down converting. For example, as shown in FIG. 11, interference detector 1102 may include a digital downconverter 1112 to down-convert the digital radar Rx signal from Rx RF chain 1116, for example, with dynamic frequency selection.

In some demonstrative aspects, as shown in FIG. 11, interference detector 1102 may include a detector Digital Frontend (DFE) component 1114, for example, to digitally process the down-converted digital radar Rx signal.

In some demonstrative aspects, as shown in FIG. 11, interference detector 1102 may include an energy detector 1138 to detect energy levels in the radar Rx signal.

In some demonstrative aspects, as shown in FIG. 11, interference detector 1102 may include a memory 1118, for example, to store data to be processed by processor 1124.

In some demonstrative aspects, interference detector 1102 may be configured to leverage the high sample rate of ADC 1122, for example, to scan for interfering radar signals, e.g., in parallel to a regular operation of a radar device implementing the interference detector 1102.

In some demonstrative aspects, interference detector 1102 may be configured to provide a technical solution to leverage a radar periodic transmission nature for identifying and/or classifying an interfering signal, e.g., as described below.

In some demonstrative aspects, processor 1124 may be configured to determine the interference detection information 1113 including one or more parameters of the interfering signal, e.g., as described below.

In some demonstrative aspects, processor 1124 may be configured to determine the interference detection information 1113 including one or more of a bandwidth of the interfering signal; a duration of the interfering signal; a repetition rate of the interfering signal; a transmission pattern of the interfering signal, e.g., a linear Frequency Modulation (FM) pattern, a Continuous Wave (CW) pattern, or the like; a window/pulse shape of the interfering signal; an inter/intra pulse coding of the interfering signal, and/or any other parameters corresponding to the interfering signal.

In some demonstrative aspects, processor 1124 may be configured to simultaneously estimate two or more of the parameters of the interfering signal, e.g., as described below.

In some demonstrative aspects, processor 1124 may provide the interference detection information 1113 to radar processor 1134, for example, at a periodic manner, e.g., every predefined period of time.

In some demonstrative aspects, radar processor 1134 may be configured to take into account the interference detection information 1113, for example, as part of radar processing performed by the radar processor 1134, e.g., to mitigate the interfering signals.

In some demonstrative aspects, radar processor 1134 may be configured to change operational settings of the radar device, e.g., time, frequency, code of pulses, pulse type, and/or the like, for example, to avoid the interfering signal, e.g., such that the interfering signal may not affect performance of the radar device.

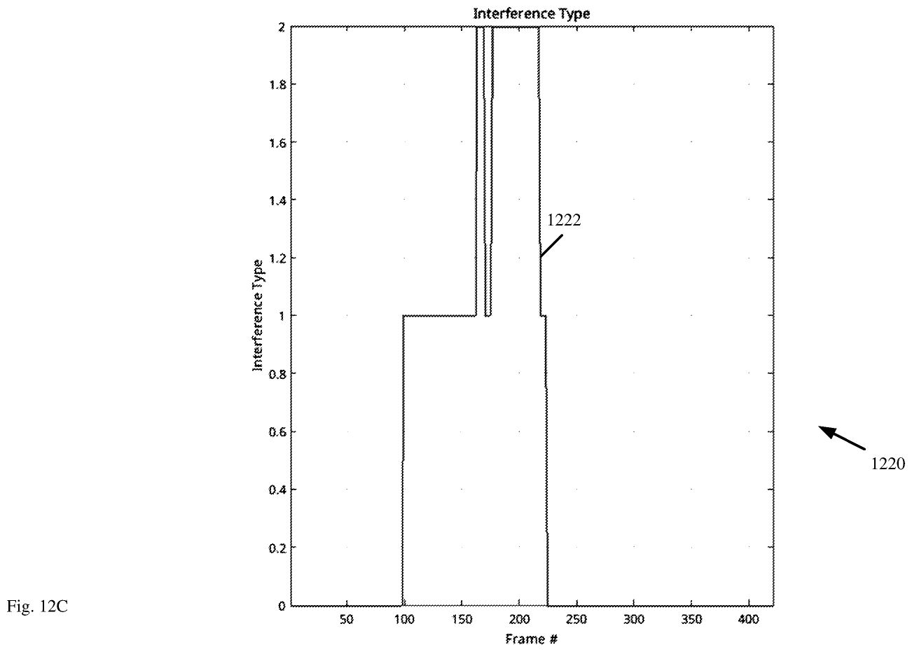

Reference is made to FIG. 12A, which schematically illustrates an interfering signal affecting a radar Rx signal, FIG. 12B which illustrates a graph 1210 depicting a noise level corresponding to the interfering signal, and FIG. 12C, which illustrates a graph 1220 depicting an interference level of the interfering signal, in accordance with some demonstrative aspects

In some demonstrative aspects, as shown in FIG. 12A, interfering signal 1212 may include Compressed TDM (CTDM) FMCW radar signal having a different slope from a slope of the radar Rx signal 1214.

In some demonstrative aspects, as shown in FIG. 12B, the graph 1210 depicts a level of a noise floor 1216 of radar Rx signal 1214, and a number of detections 1218 based on radar Rx signal 1214 versus time, e.g., frame numbers.

In some demonstrative aspects, the impact of an interferer, e.g., interfering signal 1212, may be correlated with the noise floor 1216, e.g., as described below.

In some demonstrative aspects, as shown in FIG. 12B, the level of noise floor 1216 of radar Rx signal 1214 may substantially increase, e.g., around frame 100, for example, due to interference caused by interfering signal 1212 to the radar Rx signal 1214.

In some demonstrative aspects, as shown in FIG. 12B, the level of the noise floor 1216 of radar Rx signal 1214 may substantially decrease, e.g., around frame 210, for example, when interfering signal 1212 does not affect radar Rx signal 1214 anymore.

In some demonstrative aspects, as shown in FIG. 12B, the number of detections 1218 may substantially reduce, e.g., around frame 100, for example, due to the interference cause by interfering signal 1212 to the radar Rx signal 1214.

In some demonstrative aspects, as shown in FIG. 12B, the number of detections 1218 may substantially increase, e.g., around frame 210, for example, when interfering signal 1212 does not affect radar Rx signal 1214 anymore.

In some demonstrative aspects, the impact of an interferer, e.g., interfering signal 1212, may be detected, for example, based on a noise level detection. For example, a noise level detector may be utilized to effectively correlate between an impact of an interfering signal, e.g., as represented by the reduced number of detections, to an estimation of the level of the noise floor.

In some demonstrative aspects, as shown in FIG. 12C, graph 1220 depicts an interference level 1222 versus time, e.g., a number of frame.

In some demonstrative aspects, as shown in graph 1220, the interference level 1222 may be mapped to three levels of interference impact severity, e.g., represented by the severity level values 0, 1, and 2.

For example, a first interference level, e.g., an interference level corresponding to the value 0, may indicate no interference, or a very low level of interference.

For example, a second interference level, e.g., an interference level corresponding to the value 1, may indicate a moderate level of interference.

For example, a second interference level, e.g., an interference level corresponding to the value 2, may indicate a high level of interference.

In other aspects, interference level 1222 may be mapped to any other number of interference levels.

In some demonstrative aspects, interference detection information 1013 (FIG. 10) may include a selected interference level value from the three levels of interference impact severity, e.g., a value of the values 0, 1, and 2, for example, to indicate the level of the noise floor 1216.

For example, radar processor 1034 (FIG. 10) may be configured to process the radar information of radar Rx signal 1017 (FIG. 1), for example, based on the interference level information in interference detection information 1013 (FIG. 10).

In one example, processor 1034 (FIG. 10) may be configured to select not to apply an interference mitigation mechanism, for example, when the interference level information in interference detection information 1013 (FIG. 10) indicates not interference, e.g., the interference level value 0.

In another example, processor 1034 (FIG. 10) may be configured to select not to apply a first interference mitigation mechanism, e.g., an interference canceling mechanism, for example, when the interference level information in interference detection information 1013 (FIG. 10) indicates moderate interference, e.g., the interference level value 1.

In another example, processor 1034 (FIG. 10) may be configured to select not to apply a second interference mitigation mechanism, e.g., an interference avoidance mechanism, for example, when the interference level information in interference detection information 1013 (FIG. 10) indicates a high level of interference, e.g., the interference level value 2.

In some demonstrative aspects, as shown in graph 1210, a suppression of interfering signal 1212 by about ˜15-20 Decibel (dB) may be required, for example, to restore original performance with respect to the number of detections.

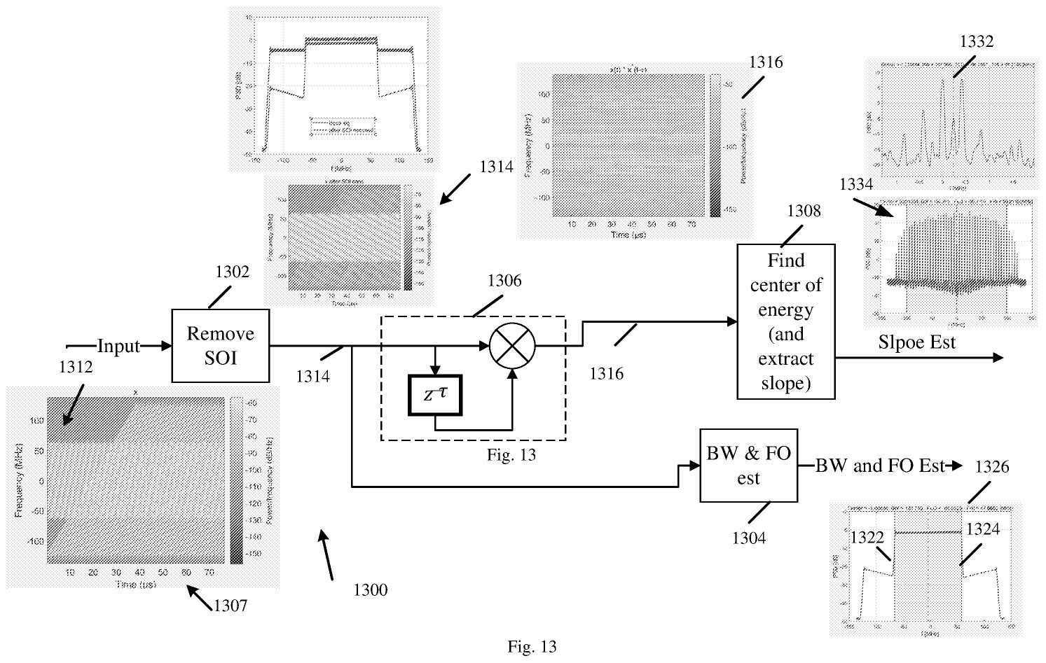

Reference is made to FIG. 13, which schematically illustrates an interference-information extraction scheme 1300 to extract interference detection information of an interfering signal 1312 in a radar Rx signal 1307, in accordance with some demonstrative aspects.

In some demonstrative aspects, a processor, e.g., processor 1024 (FIG. 10), may perform one or more operations of interference-information extraction scheme 1300, for example, to extract the interference detection information 1013 (FIG. 10).

In some demonstrative aspects, a processor, e.g., processor 1024 (FIG. 10), may perform the one or more operations of interference-information extraction scheme 1300, for example, based on detection of interfering signal 1312, e.g., based on the noise floor level as described above.

In some demonstrative aspects, as indicated at block 1302, an estimated interference signal 1314 may be determined, for example, by determining an estimated Rx signal based on a correlation between Tx parameter information of a Tx radar signal corresponding to the radar Rx signal 1307, and removing the estimated Rx signal from the radar Rx signal 1307.

In one example, a processor, e.g., processor 1024 (FIG. 10), may determine the estimated Rx signal, e.g., a Signal Of Interest (SOI), for example, by correlating the received radar signal 1307 with a known template, e.g., the Tx parameter information, estimating a channel, filtering the template with the estimated channel, and subtracting the estimated Rx signal from the radar Rx signal 1307.

In some demonstrative aspects, as indicated at block 1304, interference-information extraction scheme 1300 may include determining an estimated bandwidth of the interfering signal 1312 and/or an estimated center frequency, e.g., a frequency offset, of the interfering signal 1312.

In some demonstrative aspects, as shown in FIG. 13, a processor, e.g., processor 1024 (FIG. 10), may be configured to identify a frequency bandwidth between a first frequency 1322 and a second frequency 1324 in a power spectrum 1326 of the estimated interference signal 1314.

For example, the first frequency 1322 and/or the second frequency 1324 may be identified to may indicate boundaries of an occupied bandwidth in power spectrum 1326.

in one example, the first frequency 1322 and/or the second frequency 1324 may be identified according to an energy threshold, e.g., a 10 dB energy decrease or any other threshold, in the power level of the estimated interference signal 1314.

In some demonstrative aspects, the processor may determine the estimated bandwidth of the interfering signal 1312, for example, based on a difference between the first frequency 1322 and the second frequency 1324.

In some demonstrative aspects, the processor may determine the center frequency of the interfering signal 1312, for example, based on an average of the first frequency 1322 and the second frequency 1324.

In some demonstrative aspects, as indicated at block 1306, extraction scheme 1300 may include determining a single-tap correlated signal 1316, for example, by applying a single-tap correlation to the estimated interference signal 1314. For example, the single-tap correlation may be applied by multiplying the estimated interference signal 1314 by a delayed version of the estimated interference signal 1314 according to a time delay.

In some demonstrative aspects, as indicated at block 1308, extraction scheme 1300 may include determining an estimated slope of the interfering signal 1312, for example based on the single-tap correlated signal 1316.

In some demonstrative aspects, as shown in FIG. 13, a processor, e.g., processor 1024 (FIG. 10), may be configured to determine the estimated slope of the interfering signal 1312, for example, based on a time delay of the single-tap correlation, and based on a center frequency 1332 of a range of frequencies in a power spectrum 1334 of the single-tap correlated signal 1316.

In some demonstrative aspects, one or more operations of the extraction scheme 1300 may be implemented to provide a technical solution for relatively fast interference detection, for example, with relatively low resource utilization.

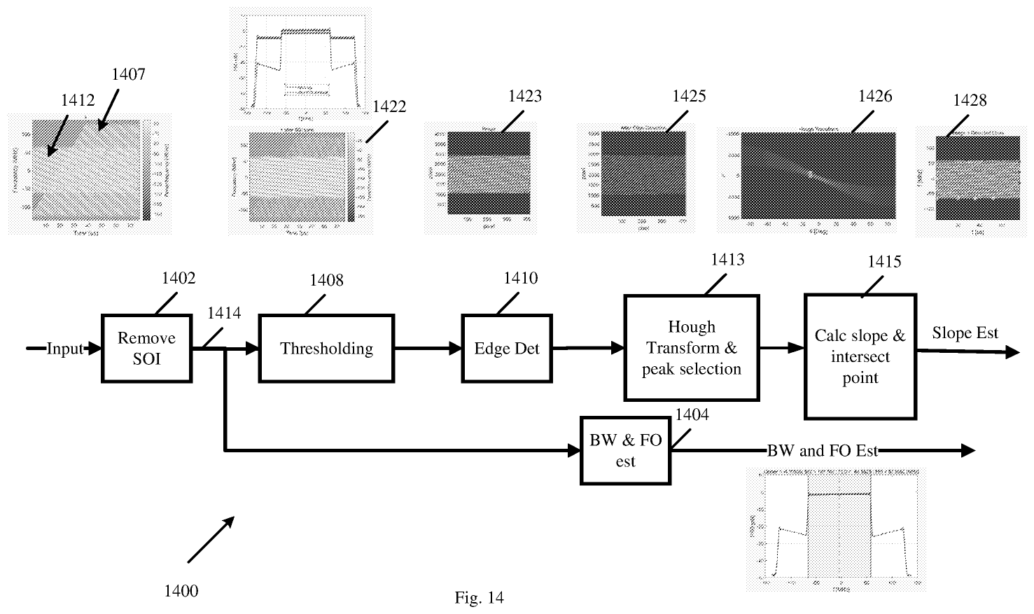

Reference is made to FIG. 14, which schematically illustrates an interference-information extraction scheme 1400 to extract interference detection information of an interfering signal 1412 in a radar Rx signal 1407, in accordance with some demonstrative aspects.

In some demonstrative aspects, a processor, e.g., processor 1024 (FIG. 10), may perform one or more operations of interference-information extraction scheme 1400, for example, to extract the interference detection information 1013 (FIG. 10).

In some demonstrative aspects, a processor, e.g., processor 1024 (FIG. 10), may perform the one or more operations of interference-information extraction scheme 1400, for example, based on detection of interfering signal 1312, e.g., based on the noise floor level as described above.

In some demonstrative aspects, as indicated by block 1402, an estimated interference signal 1414 may be determined, for example, by determining an estimated Rx signal based on a correlation between Tx parameter information of a Tx radar signal corresponding to the radar Rx signal 1407, and removing the estimated Rx signal from the radar Rx signal 1407.

In one example, a processor, e.g., processor 1024 (FIG. 10), may determine the estimated Rx signal, e.g., the SOI, for example, by correlating the received radar signal 1407 with a known template, e.g., the Tx parameter information, estimating a channel, filtering the template with the estimated channel, and subtracting the estimated Rx signal from the radar Rx signal 1407.

In some demonstrative aspects, as indicated by block 1404, interference-information extraction scheme 1400 may include determining an estimated bandwidth of the interfering signal 1412 and/or an estimated center frequency, e.g., a frequency offset, of the interfering signal 1412.

In some demonstrative aspects, as shown in FIG. 14, a processor, e.g., processor 1024 (FIG. 10), may be configured to identify a frequency bandwidth between a first frequency and a second frequency in a power spectrum of the estimated interference signal 1414, e.g., as described above.

In some demonstrative aspects, extraction scheme 1400 may include determining an estimated slope of the interfering signal 1412, for example, based on a spectrogram 1422 of the estimated interference signal 1414, e.g., as described below.

In some demonstrative aspects, as indicated at block 1408, extraction scheme 1400 may include thresholding a two-dimensional pixel image 1423 based on the spectrogram 1422, for example, based on pixel intensity values of spectrogram 1422.

In some demonstrative aspects, as indicated at block 1410, extraction scheme 1400 may include detecting edges in the two-dimensional pixel image 1423, for example, based on pixel intensity values of two-dimensional pixel image 1423, to provide a two-dimensional pixel image 1425 with detected edges.

In some demonstrative aspects, as indicated at block 1413, extraction scheme 1400 may include transforming the two-dimensional pixel image 1423 into a Hough transformed image 1426 based on a Hough transformation.

In some demonstrative aspects, as indicated at block 1415, extraction scheme 1400 may include determining the slope of the interfering signal 1412, for example, based on the Hough transformed image 1426.

In some demonstrative aspects, as shown in FIG. 14, a processor, e.g., processor 1024 (FIG. 10), may be configured to identify one or more detected lines in a two-dimensional pixel image 1428, for example, based on one or more peaks of the transformed image 1426.

In some demonstrative aspects, as shown in FIG. 14, the processor, e.g., processor 1024 (FIG. 10), may be configured to determine the slope of the interfering signal 1412, for example, based on a slope of the one or more detected lines in the two-dimensional pixel image.

In one example, the processor, e.g., processor 1024 (FIG. 10), may be configured to estimate the slope of the interfering signal 1412, for example, by determining the spectrogram, e.g., of the estimated interference signal 1414, converting the spectrogram into an image, detecting edges in the image, and measuring the slope from the image based on the Hough transform.

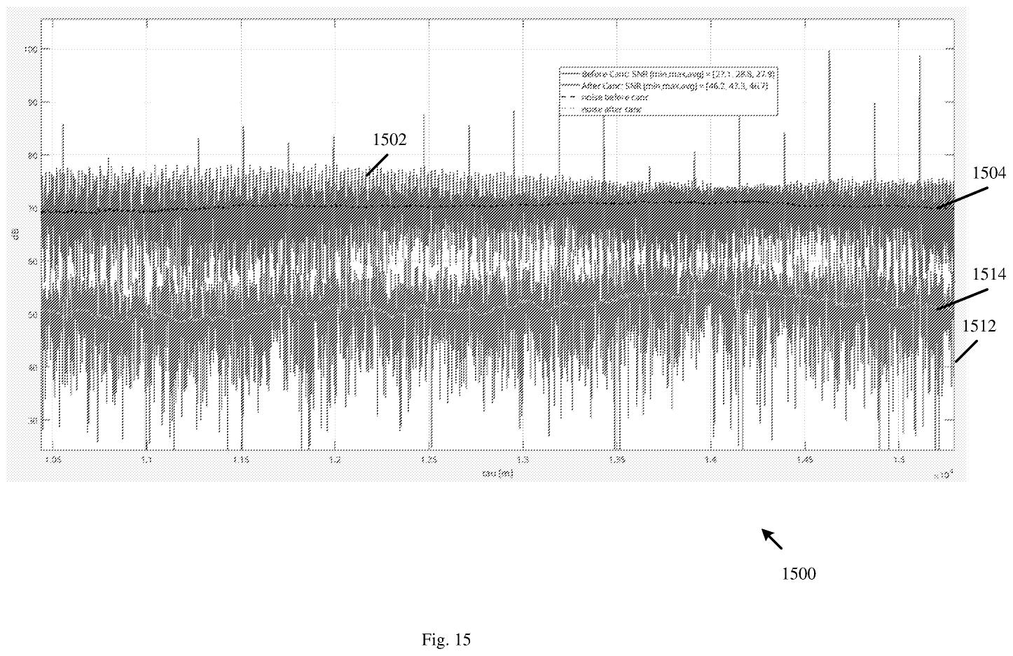

Reference is made to FIG. 15, which schematically illustrates a graph 1500 depicting an output of a correlator of a radar device, in accordance with some demonstrative aspects.

In some demonstrative aspects, as shown in FIG. 15, graph 1500 depicts a first curve 1502 representing a radar Rx signal before mitigation of an interfering signal, e.g., interfering signal 1412 (FIG. 14) or interfering signal 1312 (FIG. 13), and a noise floor 1504 of the radar Rx signal.

In some demonstrative aspects, as shown in FIG. 15, graph 1500 depicts a second curve 1512 representing the radar Rx signal after mitigation of the interfering signal, e.g., interfering signal 1412 (FIG. 14) or interfering signal 1312 (FIG. 13), and a noise floor 1514 of the radar Rx signal after the mitigation of the interfering signal.

In some demonstrative aspects, as shown in FIG. 15, mitigation of the interfering signal may achieve a decrease in the level of the noise floor, e.g., from about 70 dB of noise floor 1504 to about 50 dB of noise floor 1514. This decrease of the noise floor represents a 20 dB suppression of the interfering signal.

In some demonstrative aspects, as shown in FIG. 15, mitigation of the interfering signal may achieve an increase of the SNR of the radar Rx signal, e.g., from an average of about 28 dB (curve 1502) to an average of about 47 dB (curve 1512). This improved SNR may result in an increased number of detections, e.g., more peaks of curve 1502 may be above the noise floor 1504.

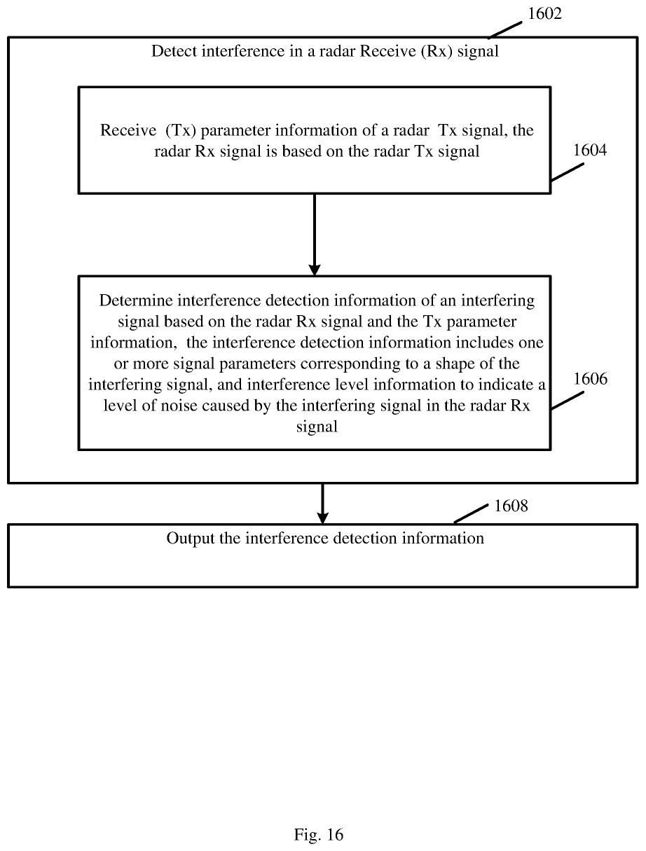

Reference is made to FIG. 16, which schematically illustrates a method of detecting interference in a radar Rx signal, in accordance with some demonstrative aspects. For example, one or more of the operations of the method of FIG. 16 may be performed by a radar system, e.g., radar system 900 (FIG. 9); a radar device, e.g., radar device 101 (FIG. 1), radar device 800 (FIG. 8), and/or radar device 910 (FIG. 9); an interference detector, e.g., interference detector 1002 (FIG. 10); a processor, e.g., processor 836 (FIG. 8), radar processor 834 (FIG. 8), processor 1024 (FIG. 10), and/or baseband processor 930 (FIG. 9); and/or a controller, e.g., controller 950 (FIG. 9).

As indicated at block 1602, the method may include detecting interference in a radar Rx signal. For example, processor 1024 (FIG. 10) may be configured to detect the interference in radar Rx signal 1007 (FIG. 10), e.g., as described above.

As indicated at block 1604, detecting the interference in the radar Rx signal may include receiving Tx parameter information of a radar Tx signal, the radar Rx signal is based on the radar Tx signal. For example, processor 1024 (FIG. 10) may receive via input 1004 (FIG. 10) the Tx parameter information 1015 (FIG. 10) of the radar Tx signal, e.g., as described above.

As indicated at block 1606, detecting the interference in the radar Rx signal may include determining interference detection information of an interfering signal based on the radar Rx signal and the Tx parameter information, the interference detection information including, for example, one or more signal parameters corresponding to a shape of the interfering signal, and/or interference level information to indicate a level of noise caused by the interfering signal in the radar Rx signal. For example, processor 1024 (FIG. 10) may be configured to determine the interference detection information 1013 (FIG. 10) of the interfering signal based on the radar Rx signal 1007 (FIG. 10) and the Tx parameter information 1015 (FIG. 10), e.g., as described above.

As indicated at block 1608, the method may include outputting the interference detection information. For example, processor 1024 (FIG. 10) may be configured to output via output 1006 (FIG. 10) the interference detection information 1013 (FIG. 10), e.g., as described above.

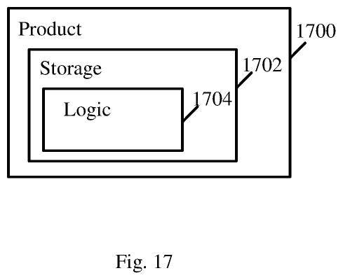

Reference is made to FIG. 17, which schematically illustrates a product of manufacture 1700, in accordance with some demonstrative aspects. Product 1700 may include one or more tangible computer-readable (“machine-readable”) non-transitory storage media 1702, which may include computer-executable instructions, e.g., implemented by logic 1704, operable to, when executed by at least one computer processor, enable the at least one computer processor to implement one or more operations at a radar system, e.g., radar system 900 (FIG. 9), a radar device, e.g., radar device 101 (FIG. 1), radar device 800 (FIG. 8), and/or radar device 910 (FIG. 9), an interference detector, e.g., interference detector 1002 (FIG. 10), a processor, e.g., processor 836 (FIG. 8), radar processor 834 (FIG. 8), processor 1024 (FIG. 10), and/or baseband processor 930 (FIG. 9), and/or a controller, e.g., controller 950 (FIG. 9); to cause a radar system, e.g., radar system 900 (FIG. 9), a radar device, e.g., radar device 101 (FIG. 1), radar device 800 (FIG. 8), and/or radar device 910 (FIG. 9), an interference detector, e.g., interference detector 1002 (FIG. 10), a processor, e.g., processor 836 (FIG. 8), radar processor 834 (FIG. 8), processor 1024 (FIG. 10), and/or baseband processor 930 (FIG. 9), and/or a controller, e.g., controller 950 (FIG. 9) to perform, trigger and/or implement one or more operations and/or functionalities; and/or to perform, trigger and/or implement one or more operations and/or functionalities described with reference to the FIGS. 1-16, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1700 and/or machine-readable storage media 1702 may include one or more types of computer-readable storage media capable of storing data, including volatile memory, non-volatile memory, removable or non-removable memory, erasable or non-erasable memory, writeable or re-writeable memory, and the like. For example, machine-readable storage media 1702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising an interference detector configured to detect interference in a radar Received (Rx) signal, the interference detector comprising an input to receive Transmit (Tx) parameter information of a radar Tx signal, wherein the radar Rx signal is based on the radar Tx signal; and a processor configured to determine interference detection information of an interfering signal based on the radar Rx signal and the Tx parameter information, wherein the interference detection information comprises one or more signal parameters corresponding to a shape of the interfering signal, and interference level information to indicate a level of noise caused by the interfering signal in the radar Rx signal; and an output to output the interference detection information.

Example 2 includes the subject matter of Example 1, and optionally, wherein the processor is configured to determine an estimated interference signal based on the radar Rx signal and Tx parameter information, and to determine the one or more signal parameters of the interfering signal based on the estimated interference signal.

Example 3 includes the subject matter of Example 2, and optionally, wherein the processor is configured to determine an estimated Rx signal based on a correlation between the Tx parameter information and the radar Rx signal, and to determine the estimated interference signal based on the estimated Rx signal and the radar Rx signal.

Example 4 includes the subject matter of Examples 2 or 3, and optionally, wherein the processor is configured to identify a frequency bandwidth between a first frequency and a second frequency in a power spectrum of the estimated interference signal, and to determine at least one signal parameter of the interfering signal based on the first frequency and the second frequency.

Example 5 includes the subject matter of Example 4, and optionally, wherein the processor is configured to determine an estimated bandwidth of the interfering signal based on the first frequency and the second frequency, and to generate the one or more signal parameters comprising the estimated bandwidth of the interfering signal.

Example 6 includes the subject matter of Example 4 or 5, and optionally, wherein the processor is configured to determine an estimated center frequency of the interfering signal based on the first frequency and the second frequency, and to generate the one or more signal parameters comprising the estimated center frequency of the interfering signal.

Example 7 includes the subject matter of any one of Examples 2-6, and optionally, wherein the processor is configured to determine a correlated signal, e.g., a single-tap correlated signal, by applying a correlation, e.g., a single-tap correlation, to the estimated interference signal, and to determine the one or more signal parameters of the interfering signal based on the correlated signal, e.g., the single-tap correlated signal.

Example 8 includes the subject matter of Example 7, and optionally, wherein the processor is configured to determine an estimated slope of the interfering signal based on a time delay of the correlated signal, e.g., the single-tap correlation, and based on a center frequency of a range of frequencies in a power spectrum of the correlated signal, e.g., the single-tap correlation signal, and to generate the one or more signal parameters comprising the estimated slope of the interfering signal.

Example 9 includes the subject matter of any one of Examples 2-6, and optionally, wherein the processor is configured to determine an estimated slope of the interfering signal based on a spectrogram of the estimated interference signal, and to generate the one or more signal parameters comprising the estimated slope of the interfering signal.

Example 10 includes the subject matter of Example 9, and optionally, wherein the processor is configured to detect a two-dimensional pixel image based on the spectrogram, to transform the two-dimensional pixel image into a transformed image defining a plurality of lines, to identify one or more detected lines in the two-dimensional pixel image based on one or more peaks of the transformed image, and to determine the slope of the interfering signal based on a slope of the one or more detected lines in the two-dimensional pixel image.

Example 11 includes the subject matter of Example 10, and optionally, wherein the transformed image comprises a Hough transformed image based on a Hough transformation.

Example 12 includes the subject matter of any one of Examples 1-11, and optionally, wherein the processor is configured to determine the interference level information based on a level of a noise floor of the radar Rx signal.

Example 13 includes the subject matter of any one of Examples 1-12, and optionally, wherein the processor is configured to determine the interference level information based on a level of detected noise in the radar Rx signal.

Example 14 includes the subject matter of Example 13, and optionally, comprising a noise detector to detect the level of detected noise in the radar Rx signal.

Example 15 includes the subject matter of any one of Examples 1-14, and optionally, wherein the interference level information comprises a selected interference level value from a plurality of predefined interference level values, the selected interference level value to indicate the level of noise caused by the interfering signal relative to the plurality of predefined interference level values.

Example 16 includes the subject matter of any one of Examples 1-15, and optionally, wherein the interference level information is configured to indicate a Signal to Interference Noise Ratio (SINR) of the radar Rx signal.

Example 17 includes the subject matter of any one of Examples 1-16, and optionally, comprising an Integrated Circuit (IC) comprising the interference detector and at least one Rx chain to provide to the processor a digital radar Rx signal based on a Radio Frequency (RF) radar Rx signal.

Example 18 includes the subject matter of Example 17, and optionally, comprising an antenna connected to the Rx chain, the antenna to receive the RF radar Rx signal.

Example 19 includes the subject matter of any one of Examples 1-18, and optionally, wherein the one or more signal parameters comprise a bandwidth of the interfering signal.

Example 20 includes the subject matter of any one of Examples 1-19, and optionally, wherein the one or more signal parameters comprise a center frequency of the interfering signal.

Example 21 includes the subject matter of any one of Examples 1-20, and optionally, wherein the one or more signal parameters comprise a slope of the interfering signal.

Example 22 includes the subject matter of any one of Examples 1-21, and optionally, wherein the one or more signal parameters comprise a duration of the interfering signal.

Example 23 includes the subject matter of any one of Examples 1-22, and optionally, comprising a radar processor configured to mitigate noise caused by the interfering signal in the radar Rx signal based on the one or more signal parameters.

Example 24 includes the subject matter of Example 23, and optionally, wherein the radar processor is configured to generate radar information based on the radar Rx signal.

Example 25 includes the subject matter of Example 24, and optionally, comprising a vehicle, the vehicle comprising a system controller to control one or more systems of the vehicle based on the radar information.

Example 26 includes a vehicle comprising the apparatus of any of Examples 1-25.

Example 27 includes an apparatus comprising means for executing any of the described operations of any of Examples 1-25.

Example 28 includes a machine-readable medium that stores instructions for execution by a processor to perform any of the described operations of any of Examples 1-25.

Example 29 comprises a product comprising one or more tangible computer-readable non-transitory storage media comprising computer-executable instructions operable to, when executed by at least one processor, enable the at least one processor to cause a device to perform any of the described operations of any of Examples 1-25.

Example 30 includes an apparatus comprising a memory; and processing circuitry configured to perform any of the described operations of any of Examples 1-25.

Example 31 includes a method including any of the described operations of any of Examples 1-25.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
an interference detector configured to detect interference in a radar Received (Rx) signal, the interference detector comprising:
an input to receive Transmit (Tx) parameter information of a radar Tx signal, wherein the radar Rx signal is based on the radar Tx signal; and
a processor configured to determine interference detection information of an interfering signal based on the radar Rx signal and the Tx parameter information, wherein the interference detection information comprises one or more signal parameters corresponding to a shape of the interfering signal, and interference level information to indicate a level of noise caused by the interfering signal in the radar Rx signal; and
an output to output the interference detection information.

2. The apparatus of claim 1, wherein the processor is configured to determine an estimated interference signal based on the radar Rx signal and Tx parameter information, and to determine the one or more signal parameters of the interfering signal based on the estimated interference signal.

3. The apparatus of claim 2, wherein the processor is configured to determine an estimated Rx signal based on a correlation between the Tx parameter information and the radar Rx signal, and to determine the estimated interference signal based on the estimated Rx signal and the radar Rx signal.

4. The apparatus of claim 2, wherein the processor is configured to identify a frequency bandwidth between a first frequency and a second frequency in a power spectrum of the estimated interference signal, and to determine at least one signal parameter of the interfering signal based on the first frequency and the second frequency.

5. The apparatus of claim 4, wherein the processor is configured to determine an estimated bandwidth of the interfering signal based on the first frequency and the second frequency, and to generate the one or more signal parameters comprising the estimated bandwidth of the interfering signal.

6. The apparatus of claim 4, wherein the processor is configured to determine an estimated center frequency of the interfering signal based on the first frequency and the second frequency, and to generate the one or more signal parameters comprising the estimated center frequency of the interfering signal.

7. The apparatus of claim 2, wherein the processor is configured to determine a correlated signal by applying a correlation to the estimated interference signal, and to determine the one or more signal parameters of the interfering signal based on the correlated signal.

8. The apparatus of claim 7, wherein the processor is configured to determine an estimated slope of the interfering signal based on a time delay of the correlation, and based on a center frequency of a range of frequencies in a power spectrum of the correlation signal, and to generate the one or more signal parameters comprising the estimated slope of the interfering signal.

9. The apparatus of claim 2, wherein the processor is configured to determine an estimated slope of the interfering signal based on a spectrogram of the estimated interference signal, and to generate the one or more signal parameters comprising the estimated slope of the interfering signal.

10. The apparatus of claim 9, wherein the processor is configured to detect a two-dimensional pixel image based on the spectrogram, to transform the two-dimensional pixel image into a transformed image defining a plurality of lines, to identify one or more detected lines in the two-dimensional pixel image based on one or more peaks of the transformed image, and to determine the slope of the interfering signal based on a slope of the one or more detected lines in the two-dimensional pixel image.

11. The apparatus of claim 10, wherein the transformed image comprises a Hough transformed image based on a Hough transformation.

12. The apparatus of claim 1, wherein the processor is configured to determine the interference level information based on a level of a noise floor of the radar Rx signal.

13. The apparatus of claim 1, wherein the processor is configured to determine the interference level information based on a level of detected noise in the radar Rx signal.

14. The apparatus of claim 1, wherein the interference level information comprises a selected interference level value from a plurality of predefined interference level values, the selected interference level value to indicate the level of noise caused by the interfering signal relative to the plurality of predefined interference level values.

15. The apparatus of claim 1, wherein the interference level information is configured to indicate a Signal to Interference Noise Ratio (SINR) of the radar Rx signal.

16. The apparatus of claim 1 comprising an Integrated Circuit (IC) comprising the interference detector and at least one Rx chain to provide to the processor a digital radar Rx signal based on a Radio Frequency (RF) radar Rx signal.

17. The apparatus of claim 16 comprising an antenna connected to the Rx chain, the antenna to receive the RF radar Rx signal.

18. The apparatus of claim 1, wherein the one or more signal parameters comprise at least one of a bandwidth of the interfering signal, a center frequency of the interfering signal, a slope of the interfering signal, or a duration of the interfering signal.

19. The apparatus of claim 1 comprising a radar processor configured to mitigate noise caused by the interfering signal in the radar Rx signal based on the one or more signal parameters.

20. A product comprising one or more tangible computer-readable non-transitory storage media comprising computer-executable instructions operable to, when executed by at least one processor, enable the at least one processor to:
determine interference detection information of an interfering signal based on a radar Received (Rx) signal and Transmit (Tx) parameter information of a radar Tx signal, wherein the radar Rx signal is based on the radar Tx signal, wherein the interference detection information comprises one or more signal parameters corresponding to a shape of the interfering signal, and interference level information to indicate a level of noise caused by the interfering signal in the radar Rx signal; and
output the interference detection information.

21. The product of claim 20, wherein the instructions, when executed, cause the processor to determine an estimated interference signal based on the radar Rx signal and Tx parameter information, and to determine the one or more signal parameters of the interfering signal based on the estimated interference signal.

22. The product of claim 21, wherein the instructions, when executed, cause the processor to identify a frequency bandwidth between a first frequency and a second frequency in a power spectrum of the estimated interference signal, and to determine at least one signal parameter of the interfering signal based on the first frequency and the second frequency.

23. The product of claim 20, wherein the interference level information comprises a selected interference level value from a plurality of predefined interference level values, the selected interference level value to indicate the level of noise caused by the interfering signal relative to the plurality of predefined interference level values.

24. A vehicle comprising:
a system controller configured to control one or more vehicular systems of the vehicle based on radar information; and
a radar system configured to generate the radar information, the radar system comprising:
a plurality of Transmit (Tx) antennas to transmit radar Tx signals;
a plurality of Receive (Rx) antennas to receive radar Rx signals based on the radar Tx signals;
an interference detector to determine interference detection information of an interfering signal based on a radar Rx signal and based on Tx parameter information of a radar Tx signal, wherein the interference detection information comprises one or more signal parameters corresponding to a shape of the interfering signal, and interference level information to indicate a level of noise caused by the interfering signal in the radar Rx signal; and
a processor configured to determine the radar information based on the radar Rx signals and the interference detection information.

25. The vehicle of claim 24, wherein the one or more signal parameters comprise at least one of a bandwidth of the interfering signal, a center frequency of the interfering signal, a slope of the interfering signal, or a duration of the interfering signal.
